(19) United States
(12) Patent Application Publication
(10) Pub. No.: US 2004/0184523 A1
(43) Pub. Date: Sep. 23, 2004

(54) Method and system for providing reduced bandwidth for picture in picture video transmissions

(76) Inventors: Thomas Patrick Dawson, Escondido, CA (US); Christopher Jensen Read, San Diego, CA (US)

Correspondence Address: WAGNER, MURABITO & HAO LLP, Third Floor, Two North Market Street, San Jose, CA, 95113, US

(21) Appl. No.: 10/374,950

(22) Filed: Feb. 25, 2003

(51) Int. Cl. H04N 7/12

(52) U.S. Cl. 375/240.1; 375/240.26

(57) ABSTRACT

A method and system for providing reduced network bandwidth for picture in picture (PIP) video transmissions. The method includes receiving a request signal from a client display to scale a video signal, a server scaling an auxiliary video signal from which pictures presented in an auxiliary display of a client display are derived and the server encoding signals from which pictures presented in a main display and a auxiliary display of said client display are derived. Further, the method includes combining the signals from which pictures presented in the main display and the auxiliary display are derived and the server transmitting to the client display combined signals from which pictures presented in the main display and the auxiliary display are derived. The client then displays the main image and the PIP image.

### TECHNICAL FIELD

Embodiments of the present invention relate generally to picture in picture (PIP) video transmission. In particular, embodiments of the present invention relate to a method and system for dynamically reducing network bandwidth for (PIP) video transmissions in order to preserve bandwidth for the main video picture.

### BACKGROUND ART

Many conventional image display systems possess the ability to display a small auxiliary image in addition to a larger main image where both are simultaneously displayed on a display screen or television. The smaller image may be displayed within the boundaries of the larger main picture, in which case, such a system is termed a picture-in-picture (PIP) system. The main and auxiliary images may be derived from the same video signal, such as with a freeze frame PIP image of the main image, or may be derived from an independent source, such as with a system in which one tuner tunes one video signal which is displayed as the main image, and a second tuner tunes a second video signal, independent of the first tuner, which is displayed as the inset image.

Conventional PIP systems operate by receiving full resolution image data which represents auxiliary images, and scaling and displaying the image data in the form of auxiliary video signals. Auxiliary video signals corresponding to the scaled image data are substituted for portions of the main video signal that represent portions of the main image that have been designated as locations to display the auxiliary or PIP image.

FIG. 1 shows a conventional PIP system 100 including a video content server 101 and a client display 103 that includes main video display 107, PIP display 109 and video scaler unit 105. Among conventional systems that support the transmitting and receiving of video signals over wireless networks, such as that shown in FIG. 1, a common practice is to display a small auxiliary image derived from an auxiliary video signal in a small inset window 109 within the main video display 107. This small inset window is called a PIP display (e.g. 109). These systems accommodate the reception of a full resolution version of the auxiliary video signal which is thereafter scaled down to a size required for presentation in the PIP display 109 (such as by video scaler 105). For PIP network video systems, this presents the challenge of accommodating the entire full resolution video signal for the auxiliary image despite the limited bandwidth that may be available. Also, conventional PIP implementations rely on the display device to do the computationally expensive work of scaling down the full resolution image.

### SUMMARY OF THE INVENTION

Accordingly, a need exists for a method and system that reduces the size of the bandwidth required to accommodate the video shown in a PIP display and that eliminates the scaling requirement of the client display device. The present invention provides a method and system which accomplishes this need.

For instance, one embodiment of the present invention includes a method and system for reducing the transmission bandwidth of picture in picture (PIP) video transmissions. The method includes receiving a request signal from a client (display) to scale a video signal, subsequently scaling an auxiliary video signal from which pictures presented in an auxiliary display of a client display are derived (e.g., to a smaller size) in response to the request signal and encoding the signals from which pictures presented in a main display and an auxiliary display of the client display are derived. Additionally, the method includes combining the signals from which pictures presented in the main display and the auxiliary display are derived and transmitting to the client display the combined signals.

Therefore, responsive to the client request, the content server scales the video for a second video source to a smaller size, e.g., 176×120 for instance, prior to transmitting it. The lower resolution reduces the bandwidth required for transmission. The client can then display the reduced video without scaling as the PIP display. The PIP window could also have a reduced frame rate or lower image quality due to the smaller display size. This would further reduce the bandwidth required for PIP transmission.

In one embodiment, the amount of bandwidth space allocated to components of the video output signal corresponding to an auxiliary video image and a main video image respectively may be adjusted. According to one embodiment, the bandwidth space allocated to components of the video output signal corresponding to the auxiliary video image may be reduced and the bandwidth space allocated to components of the video output signal corresponding to the main video image may be maintained at former levels.

In another embodiment of the present invention a content server dynamically adjusts parameters according to available bandwidth. In such embodiments, the parameters may include frame rate and image quality.

These and other advantages of the present invention will no doubt become obvious to those of ordinary skill in the art after having read the following detailed description of the preferred embodiments which are illustrated in the drawing figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 shows a conventional implementation of a PIP system.

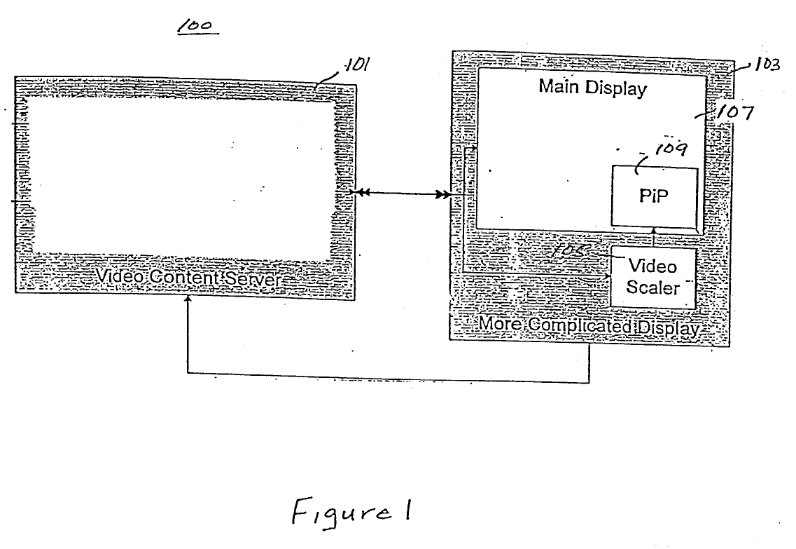

FIG. 2 shows a picture in picture (PIP) implementation according to one embodiment of the present invention.

FIG. 3 is a functional block diagram illustrating the functional blocks of the bandwidth adjusting operations according to one embodiment of the present invention.

FIG. 4A is a diagram illustrating an example of the relative band width space of the video output signals signal bandwidth occupied by signal components corresponding to the auxiliary and main video images according to one embodiment of the present invention.

FIG. 4B illustrates system operation where there is a loss in the bandwidth available to accommodate reception of the output video signal according to one embodiment of the present invention.

FIG. 5A shows a flow chart of the steps performed in a process for scaling and transmitting video signals according to one embodiment of the present invention.

FIG. 5B shows a flowchart of the steps performed in a method for receiving and presenting a video signal according to one embodiment of the present invention.

FIG. 6 shows a flowchart of the steps performed in a method for adjusting a previous allocation of video output signal bandwidth space according to one embodiment of the present invention.

FIG. 7 shows a flowchart of the steps performed in a method for dynamically adjusting parameters according to one embodiment of the present invention.

FIG. 8 is a block diagram of hardware components and the associated data processing infrastructure of a content server according to one embodiment of the present invention.

FIG. 9 is a block diagram of hardware components and the associated data processing infrastructure of a client receiver and display unit according to one embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

### Notation and Nomenclature

Some portions of the detailed descriptions which follow are presented in terms of procedures, logic blocks, processing, and other symbolic representations of operations on data bits within a computer system, server system or electronic computing device. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the present invention.

It should be borne in mind, however, that all of these terms are to be interpreted as referencing physical manipulations and quantities and are merely convenient labels and are to be interpreted further in view of terms commonly used in the art. Unless specifically stated otherwise as apparent from the following discussions, it is understood that throughout discussions of the present invention, discussions utilizing terms such as “receiving” or “scaling” or “encoding” or the like, refer to the action and processes of a computer system, or similar electronic computing device, that manipulates and transforms data. For example, the data is represented as physical (electronic) quantities within the computer system's registers and memories and is transformed into other data similarly represented as physical quantities within the computer system memories or registers or other such information storage, transmission, or display devices.

### Providing Reduced Bandwidth for Picture in Picture Video Transmissions

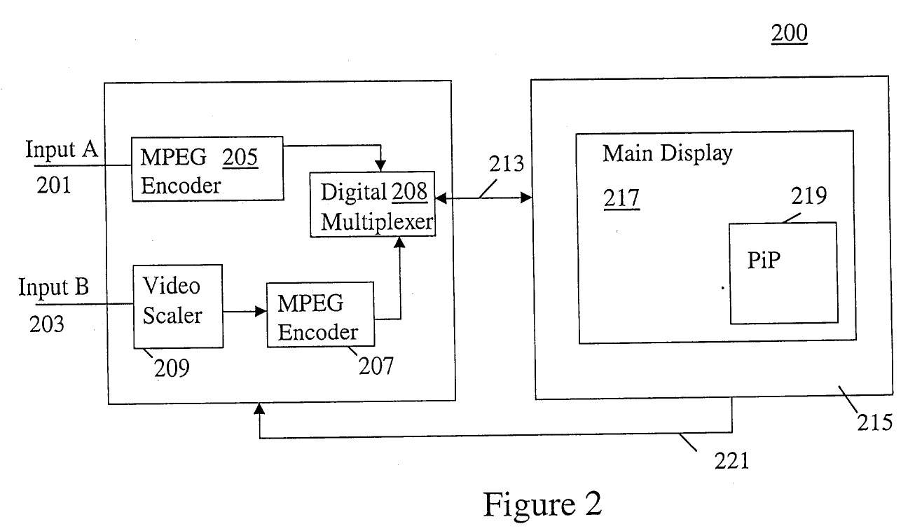

FIG. 2 shows a wireless picture in picture (PIP) network 200 according to one embodiment of the present invention. Embodiments of the present invention-provide a client display 215 that facilitates the transmission of a request signal to a content server 211 which prompts the scaling of an auxiliary video signal by the content server 211 to a smaller size prior to the transmission of the auxiliary video signal to the client display 215.

In one embodiment, the content server 211 may be a wireless content server. The lower resolution picture resulting from this operation reduces the bandwidth required to accommodate the transmission of a video output signal containing the auxiliary video signal as a component. The client display 215 may then display (in PIP window 219) video images derived from the auxiliary video signal without having to scale the auxiliary video signal for presentation of video images derived therefrom in the PIP display 219. It should be appreciated that according to one embodiment, a video scaler 209 resident in a digital encoder of the video content server 211 may perform the aforementioned scaling operations. FIG. 2 shows video input A 201, video input B 203, MPEG encoder 205, MPEG encoder 207, video scaler 209, video content server 211, video output signal 213, display device 215, PIP display 219, main video display 217, and request signal 221, and digital multiplexer 208.

Video inputs (e.g., 201 and 203) receive the video signals from which the pictures to be presented in the main video display 217 and the PIP display 219 are respectively derived. According to exemplary embodiments of the present invention these video signals may be generated from the same or different sources. According to such embodiments, video input A 201 may be encoded (transformed into a digital signal) prior to its transmission to display device 215. Moreover, video input B 203 (the auxiliary video signal) may be scaled (such as by video scalar 209) to a smaller size and encoded (such as by MPEG encoder 205) prior to its transmission to display device 215.

Video content server 211 receives video signal inputs (e.g., via video inputs 201 and 203) and transmits a corresponding output signal (e.g., 213) to display device 215. According to exemplary embodiments, video content server 211 may also receive communications from the display device 215 (e.g., in the form of a request signal 221). Video content server 211 includes MPEG encoder 205, MPEG encoder 207, and video scaler 209. Utilizing these components, video content server 211 generates digital video signals from video input 203 and scaled video input 209 and multiplexes 208 the transmission of this digital information to the display client 215. In one embodiment, the transmission is wireless, but in other embodiments the transmission medium may include but is not limited to a wired network, coaxial cable, home phoneline networking alliance (HPNA), or home power line network.

Video scaler 209 performs a scaling operation on the video signal received by video input B (e.g. 203) from which picture images to be presented in the PIP display 219 are derived. According to exemplary embodiments, the scaled video signal may be digitally encoded and multiplexed with the digital video signal from which the picture images to be presented in the main display are derived. It should be appreciated that according to such embodiments, the scaling operation may be performed in accordance with the information provided in request signal 221.

MPEG encoders 205 and 207 digitally encode the video signals from which the pictures to be presented in the main video display 217 and the PIP display 219 are respectively derived. According to exemplary embodiments, these signals are multiplexed to form the digital signal 213 that is transmitted to display device 215.

Display device 215 provides a small PIP display 219 inside the devices larger main video display 217 area for presenting picture images. Main and auxiliary picture images may be derived from the same video signal source, or may be derived from independent video signal sources as previously mentioned. According to exemplary embodiments of the present invention, the digital video signal 213 received by display device 215 may include multiplexed components corresponding to both the main and the auxiliary video images. It should be appreciated that the display device 215 may communicate with the video content server by means of a request signal 221. This signal provides information that prompts the video content servers scaling operations.

As previously mentioned, request signal 221 provides information that prompts the video scaling processes described herein. According to exemplary embodiments, this information may communicate bandwidth availability data that may be used to direct the adjustment of the video image resolution of the auxiliary picture image. According to one embodiment, the server 211 may dynamically adjust parameters such as frame rate and image quality based on information provided by request signal 221. According to this embodiment, the frame rate and image quality of the transmitted pictures could be adjusted dynamically by the video content server in order to maintain bandwidth availability for the main video display 217.

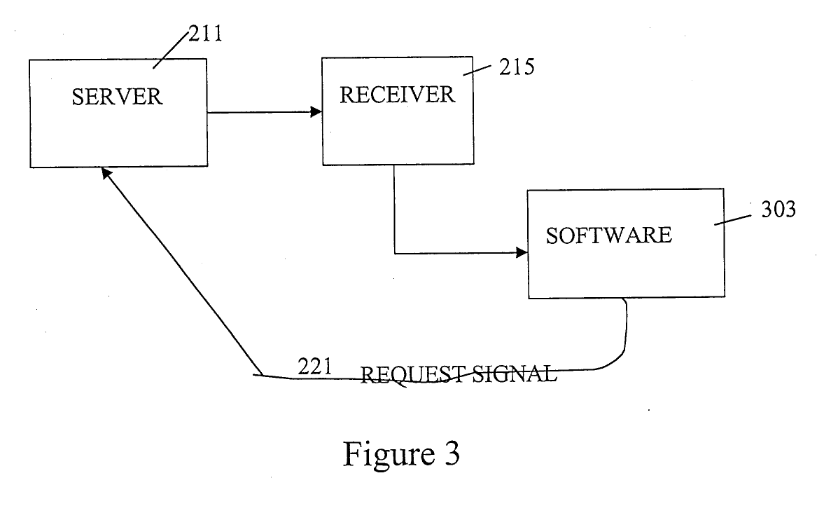

FIG. 3 is a functional block diagram illustrating the functional blocks of the bandwidth adjusting operations according to one embodiment of the present invention. According to exemplary embodiments, a receiver (e.g., client display 215) may communicate bandwidth availability data to a video content server which prompts the adjusting of the relative band width space occupied by component portions of the server output signal that correspond to the main and auxiliary images. According to such embodiments this adjusting may be executed in response to changes in the available bandwidth. FIG. 3 shows video content server 211, receiver (e.g., display device 215), video output signal 213, request signal 221 and receiver software 303.

According to exemplary embodiments of the present invention, an event that causes a loss in the bandwidth available to accommodate the reception of the video output signal 213 may trigger the appropriation of bandwidth formerly appropriated to components of the video output signal 213 that correspond to the auxiliary video image, to components of the video output signal 213 that correspond to the main video image. As is shown in FIG. 3, requests for an appropriation of additional bandwidth are communicated to the video content server 211 from the receiver (e.g., display 215) by means of request signal 221. According to one embodiment, the receiver software 303 may receive information from internal receiver components reflecting a loss in the bandwidth that may be available to accommodate the reception of the multiplexed digital video output signal 213. This information may be used to generate a request signal that prompts the execution of an adjustment in the relative band width space allocated to component portions of the multiplexed digital video output signal (e.g., 213) that correspond to the main and auxiliary images respectively.

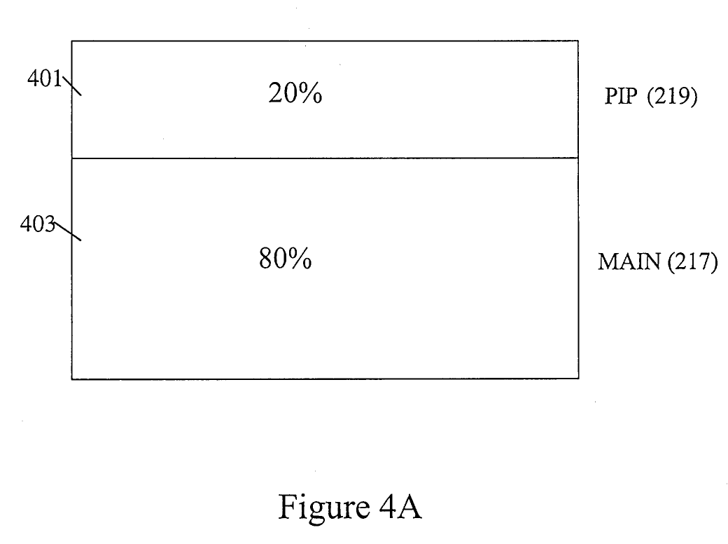

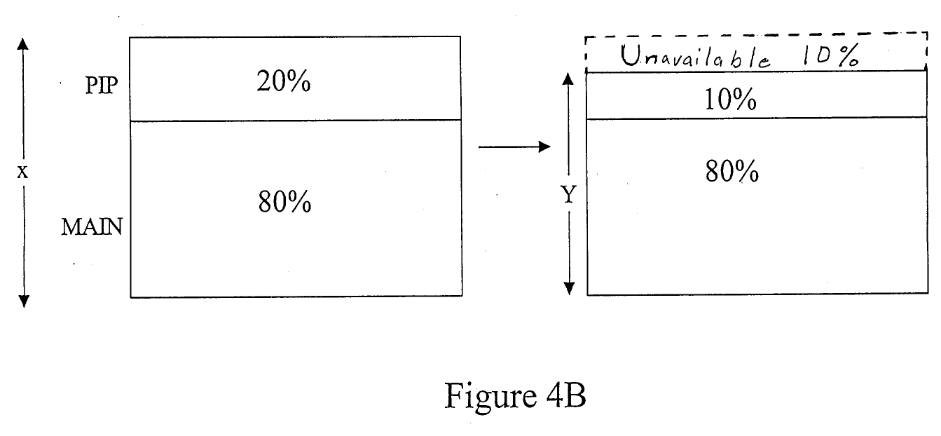

FIG. 4A is a diagram 400 illustrating an example of the relative bandwidth space of the video output signals signal bandwidth occupied by signal components corresponding to the auxiliary and main video images according to one embodiment of the present invention. FIG. 4A shows the respective bandwidth space of the video output signals bandwidth that is occupied by the PIP and main component (401 and 403 respectively) of the video output signal 213. In the FIG. 4A example, PIP component 401 is allocated 20% and the main component 403 80% of the video output signal bandwidth. It should be appreciated that the relative bandwidth spaces depicted in FIG. 4A are only exemplary and embodiments of the present invention may include but are not limited to this allocation of bandwidth space.

FIG. 4B illustrates system operation where there is a loss (x to y) in the bandwidth available to accommodate reception of the output video signal according to one embodiment of the present invention. It should be appreciated that a loss in the bandwidth available to accommodate reception of the output video signal may trigger the appropriation of signal bandwidth formerly allocated to video output signal components (e.g., 213) that correspond to the auxiliary video image, to video output signal components that correspond to the main video image, as is illustrated in the diagrams of FIG. 4B. FIG. 4B illustrates the operation of the system when there has been a reduction in the bandwidth available to accommodate reception of the multiplexed digital video signal received by the client display from 100% to 90% of its former magnitude (the unavailable bandwidth is represented by the broken line segment). In such cases, the bandwidth space allocated to digital video output signal components corresponding to the main picture may be maintained at former levels. However, the bandwidth allocated to digital video output signal components corresponding to the auxiliary video image may be reduced by an amount commensurate with the reduction in bandwidth available for reception of the multiplexed digital video signal. In the example shown in FIG. 4B bandwidth available to receive the multiplexed digital video signal is reduced by 10% (from 100% to 90% of its former value). Consequently, the space allocated to digital video output signal components corresponding to the auxiliary video image is reduced by half.

### Exemplary Operations in Accordance with Embodiments of the Present Invention

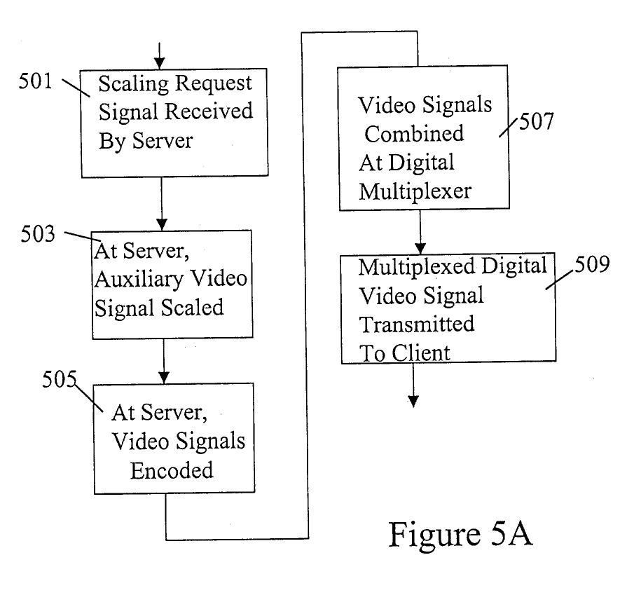

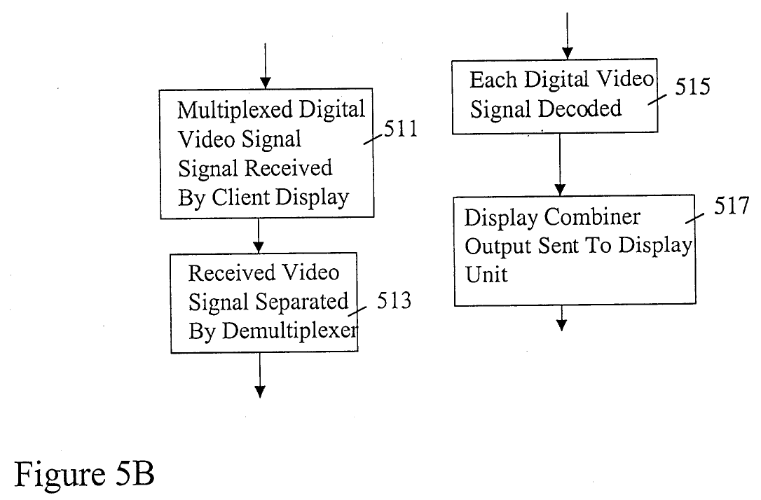

FIGS. 5A-7 are a flowcharts of steps performed in accordance with one embodiment of the present invention. The flowcharts illustrate processes of the present invention which, in one embodiment, are carried out by processors and electrical components under the control of computer readable and computer executable instructions. The computer readable and computer executable instructions may reside, for example, in data storage features such as computer usable volatile memory and/or computer usable non-volatile memory. However, the computer readable and computer executable instructions may reside in any type of computer readable medium. Although specific steps are disclosed in these flowcharts, such steps are exemplary. That is, the present invention is well suited to performing various other steps or variations of the steps recited in FIGS. 5A-7. Within the present embodiment, it should be appreciated that the steps of the flowchart may be performed by software, by hardware or by any combination of software and hardware.

FIG. 5A shows a flow chart of the steps performed in a process for scaling and transmitting video signals, as described herein, according to one embodiment of the present invention.

At step 501, a scaling request signal is received by the video content server. The scaling request signal is transmitted from the receiver (e.g., display 215).

At step 503, the auxiliary video signal (supplied via video input B 203) is scaled. In this operation a video scaler (e.g., 209) performs a scaling operation on the auxiliary video signal (supplied via video signal input B 203). It should be appreciated that images to be presented in the PIP display (e.g., 219) are derived from the auxiliary video signal. According to exemplary embodiments, the scaled video signal may be encoded and digitally multiplexed with the video signal from which the pictures to be presented in the main display are derived (see steps 505 and 507 below).

At step 505, the signals are encoded. MPEG encoders (e.g., 205 and 207) encode the video signals from which the picture images to be presented in the main video display (e.g., 217) and the PIP display (e.g., 219) are respectively derived. According to exemplary embodiments, these signals are multiplexed together to form a digital video signal (e.g., 213) that is transmitted to display device (e.g., 215).

At step 507, the video signals are multiplexed together. Multiplexer 208 processes and combines the encoded digital data inputs (see FIG. 2, structures 201 and 203) to form a multiplexed digital video signal output (e.g., 213) to be transmitted to a display device (e.g., 215). And, at step 509, a multiplexed digital video signal from which auxiliary and main images may be derived is transmitted to the display device (e.g., 215).

FIG. 5B shows a flowchart of the steps performed in a method for receiving a video signal and presenting picture images corresponding to components of the video signal according to one embodiment of the present invention as herein described.

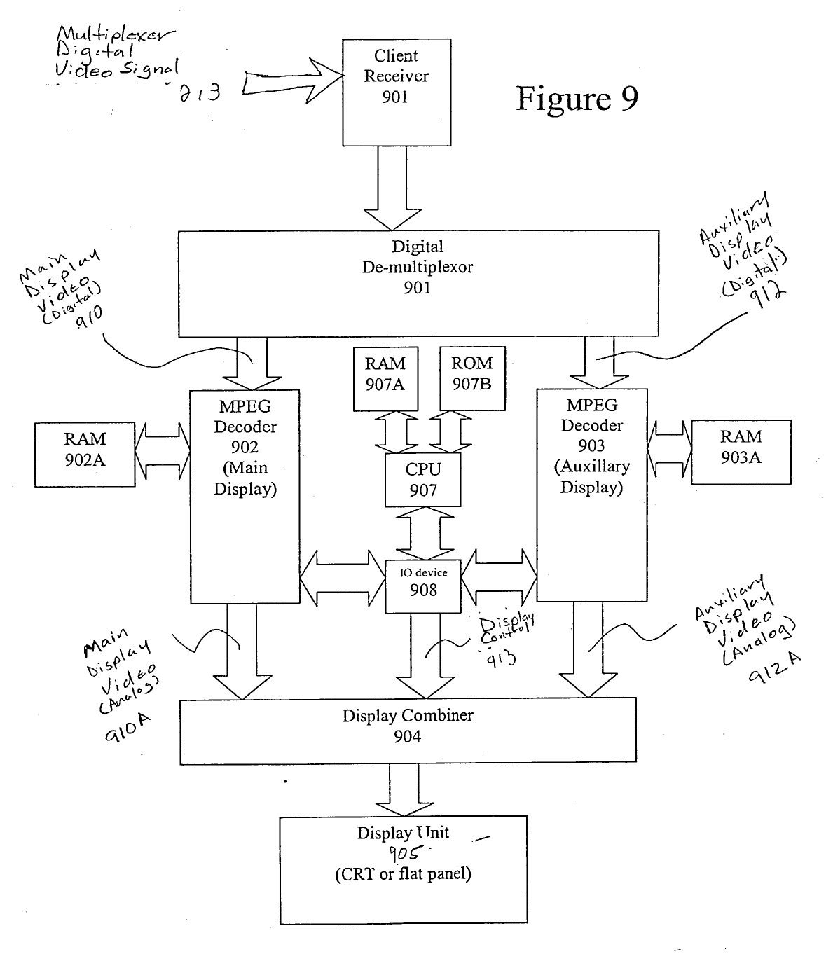

At step 511, the multiplexed digital video signal transmitted by the server is received. From this signal the auxiliary and main images may be derived. At step 513, the received signal is separated by a demultiplexer (see demultiplexer 902 discussed with reference to FIG. 9) into separate digital components corresponding to the auxiliary and the main images respectively.

At step 515, each digital video signal is decoded (see decoders 902 and 903 discussed with reference to FIG. 9). And, at step 515 the digital video signals decoded at step 513 are combined by a display combiner and transmitted to a display unit (see display combiner 904 and display unit 215 discussed with reference to FIG. 9) for presentation in a displayable format.

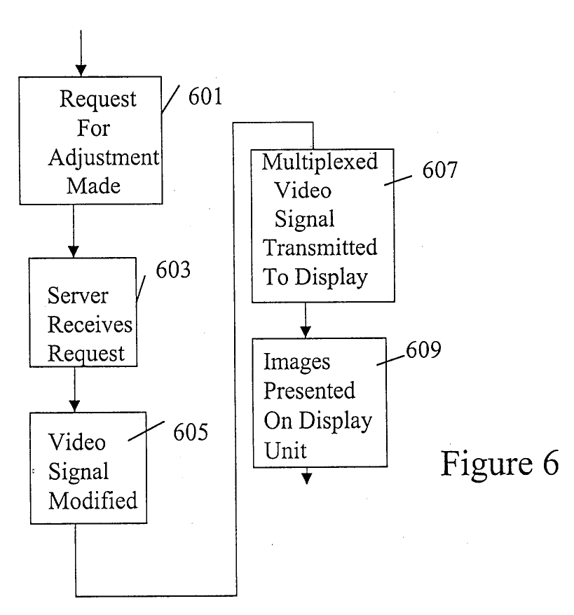

FIG. 6 shows a flowchart of the steps performed in a method for adjusting a previous allocation of video output signal bandwidth space according to one embodiment of the present invention as described with reference to FIG. 4B.

At step 601, the display device transmits a request to the content server that prompts the content server to scale the auxiliary video signal (supplied via video input B 203). As is shown in FIG. 3, requests that the auxiliary video signal be scaled are communicated to the video content server (e.g., 211) from the receiver (e.g., 215) by means of request signal (e.g., 221).

At step 603, the server receives the transmitted request that prompts the content server to scale the auxiliary video signal (supplied via video input B 203). And, at step 605, the server alters the bandwidth space distribution of the video output signal by adjusting the amount of bandwidth space allocated to the components of the multiplexed digital video signal corresponding to the auxiliary video images. This is done by increasing image compression and reducing frame rate. It should be appreciated that while there has been a reduction in the bandwidth of the output video signal, the bandwidth space allocated to video output signal components corresponding to the main picture can be maintained at former levels. However, the space allocated to video output signal components corresponding to the auxiliary video image may be reduced by an amount commensurate with the reduction of the available bandwidth. It is appreciated that the loss of bandwidth may be detected by the client display in response to loss or dropped packets becoming noticed. Alternatively, the loss of bandwidth may be detected in response to a user input, e.g., in response to perceived picture quality.

At step 607, an adjusted video output signal is transmitted to the display device. And, at step 609, images derived from the adjusted video output signal are presented. It should be appreciated that according to one embodiment, because a video scaler resident in an encoder of the server may perform the scaling operations that are a part of the video output signal adjustment process, the client may then display video images derived therefrom without having to scale the auxiliary video signal for presentation in the PIP display.

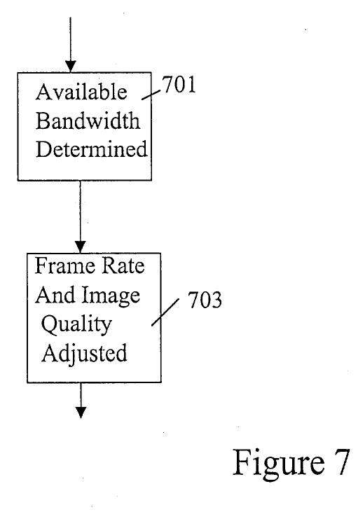

In an alternative embodiment, the server may adjust parameters of a transmitted video signal in order to maintain the availability of bandwidth for the main video display. FIG. 7 shows a flowchart of the steps performed in a method for dynamically adjusting parameters of a transmitted video signal according to one embodiment of the present invention.

At step 701, the available bandwidth of the network is determined by the server. And, at step 703, the frame rate and image quality of the transmitted video signal is adjusted according to available bandwidth. It should be appreciated that the PIP resolution can be kept constant, while the frame rate and image quality of the transmitted pictures are varied dynamically to keep bandwidth available for the main video display (e.g., 217). In addition, the space in the main picture that is occupied by the PIP can be left blank in order to save the bandwidth space occupied by the bits that describe the pixels that are being obscured by the PIP.

### Exemplary Hardware in Accordance with Embodiments of the Present Invention

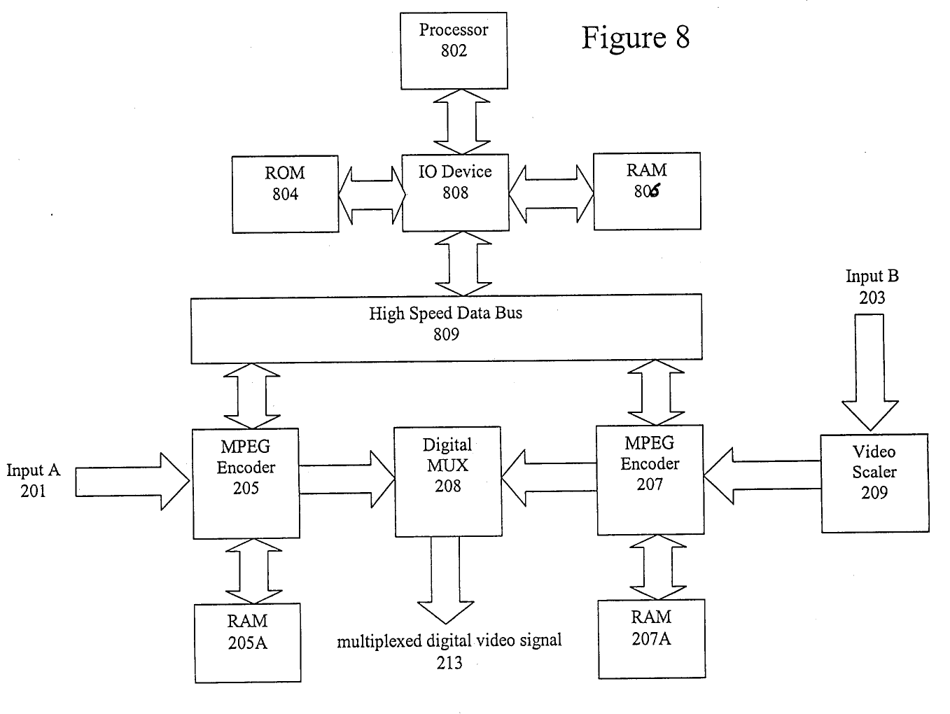

FIG. 8 is a block diagram of hardware components and the associated data processing infrastructure of a content server according to one embodiment of the present invention. Referring to FIG. 8, the ROM 804 and RAM 806 memory units of the server may contain application programs, components thereof and/or other data which may support all or parts of the functionality exhibited by the server. Processor 802 processes data and communicates instructions via I/O device 808 over high speed data bus 809 to server components such as MPEG encoders 205 and 207.

The instructions communicated by processor 802 may be used by the encoders to control server operations such as the digitization and compression of video signals received via input A 201 and input B 203. It should be appreciated that according to one embodiment of the invention, each of the MPEG encoders 205 and 207 may possess associated memory units such as RAM units 205A and 207A which may store application programs, components thereof and/or other data that support all or part of the functionality of the associated encoders.

MPEG encoders 205 and 207 digitize and compress video signals that are received via input A 201 and input B 203. The video signals may thereafter be multiplexed by digital multiplexer 208. The multiplexed digital video signal 213 may include scaled video signal components received via input B (scaled by video scaler 209) from which images presented in the PIP display are derived. Moreover, the multiplexed digital video signal may also include video signal components received via input A from which images presented in the main display are derived.

FIG. 9 is a block diagram of hardware components and the associated data processing infrastructure of a client receiver and display unit according to one embodiment of the present invention. Referring to FIG. 9, the ROM 907A and RAM 907B memory units of the receiver may contain application programs, components thereof and/or other data which may support all or parts of the functionality exhibited by the receiver. CPU 907 processes data and communicates instructions via I/O device 908 to receiver components such as MPEG decoders 902 and 903.

Client receiver 901 receives multiplexed digital video signal 213 and thereafter transmits the received signal to digital demultiplexer 901. The digital demultiplexer 901 therefrom generates digital video signals 910 and 912 from which images presented in the main and auxiliary display respectively are derived. MPEG decoders 902 and 903 (which may possess associated memory devices 902A and 903A) decode digital video signals 910 and 912 (producing analog video signals 910A and 910B) and transmit them to display combiner 904 along with a display control signal 904 supplied by I/O device 908. The display combiner 904 combines analog video signals 910A and 912A and generates a video signal from which the images presented in display unit 905 (e.g., FIG. 2, structure 215) are derived.

As noted above with reference to exemplary embodiments thereof, the present invention sets forth a method and system for providing reduced network bandwidth for picture in picture (PIP) video transmissions. The method includes receiving a request signal from a client display to scale a video signal, scaling an auxiliary video signal from which pictures presented in an auxiliary display of a client display are derived and encoding signals from which pictures presented in a main display and a auxiliary display of said client display are derived. Further the method includes combining the signals from which pictures presented in the main display and the auxiliary display are derived within a digital multiplexer and transmitting to the client display combined signals from which pictures presented in the main display and the auxiliary display are derived.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for providing reduced network bandwidth for picture in picture (PIP) video transmissions comprising:
receiving a request signal from a client display to scale a video signal;
scaling an auxiliary video signal from which pictures presented in an auxiliary display of said client display are derived;
digitally encoding signals from which pictures presented in a main display and said auxiliary display of said client display are derived;
multiplexing together said digital signals from which pictures presented in said main display and said auxiliary display are derived; and
transmitting to said client display multiplexed digital signal from which pictures presented in said main display and said auxiliary display are derived.

2. The method of claim 1, wherein said receiving is performed by a wireless content server.

3. The method of claim 2, wherein said scaling is performed by a video scalar of said wireless content server.

4. The method of claim 3, further comprising said wireless content server dynamically adjusting parameters according to available bandwidth.

5. The method of claim 4, wherein said parameters comprise frame rate and image quality, wherein said image quality is adjusted according to the level of digital compression that is applied during digital encoding.

6. The method of claim 1, wherein said request signal requests additional bandwidth for the main video.

7. The method of claim 6, wherein said digital encoding comprises adjusting the amount of bandwidth allocated to the components of the combined signals corresponding to an auxiliary video image and a main video image respectively, wherein said adjusting comprises adjusting parameters according to available bandwidth.

8. The method of claim 7, wherein said digital encoding comprises reducing the bandwidth space allocated to components of the combined signals corresponding to said auxiliary video image and maintaining or increasing the bandwidth space allocated to components of the combined signals corresponding to said main video image.

9. The method of claim 2, further comprising:
receiving a multiplexed digital video signal transmitted from said wireless content server;
separating the received signal into separate digital video signals corresponding to auxiliary and main picture images and decoding said digital video signals wherein said digital video signals are organized into a displayable video format; and
presenting picture images corresponding to said auxiliary and main picture images in PIP and main displays respectively of said client display.

10. The method of claim 9, wherein said main and auxiliary picture images are derived from the same image source, or from independent sources.

11. The method of claim 9 wherein a portion of said main picture image obscured by said PIP image is left blank so as to increase bandwidth space allocated to video signal components corresponding to said main picture image.

12. A computer server comprising a processor and computer useable medium having computer useable code embodied therein causing said processor to perform operations comprising:
receiving a request signal from a client display to scale a video signal;
scaling an auxiliary video signal from which pictures presented in an auxiliary display of said client display are derived;
digitally encoding signals from which pictures presented in a main display and said auxiliary display of said client display are derived;
multiplexing said digital signals from which pictures presented in said main display and said auxiliary display are derived; and
transmitting to said client display a combined digital signal from which pictures presented in said main display and said auxiliary display are derived.

13. The content server of claim 12, wherein said receiving is performed via a wired network connection.

14. The content server of claim 12, wherein said transmitting is performed wirelessly, by HPNA (Home Phoneline Networkworking Alliance), COAX, or cable.

15. The content server of claim 14, wherein said method further comprises dynamically adjusting parameters according to available bandwidth.

16. The content server of claim 15, wherein said parameters comprise frame rate and image quality of said signals wherein said image quality is adjusted according to the level of digital compression that is applied during digital encoding.

17. The content server of claim 12, wherein said request signal requests additional bandwidth for the main video image.

18. The content server of claim 17, wherein said encoding comprises adjusting the amount of bandwidth space allocated to the components of the combined signals corresponding to an auxiliary video image and a main video image respectively.

19. The content server of claim 18, wherein said encoding comprises reducing the bandwidth space allocated to components of the video output signal corresponding to said auxiliary video image and maintaining or increasing the bandwidth space allocated to components of the video output signal corresponding to said main video image.

20. The content server of claim 19, wherein a portion of said main video image obscured by a picture in picture (PIP) image is left blank so as to increase bandwidth space allocated to video signal components corresponding to said main video image.

21. A system comprising:
a content server accessing a first video signal and a second video signal, said content server comprising:
a first encoder for digitally encoding said first video signal comprising a main image for display on a client display;
a scaler for scaling said second video signal comprising a picture-in-picture (PIP) image for display on said client display, said scaler scaling according to a request signal from said client display; and
a second digital encoder for encoding an output of said scaler, wherein said content server multiplexes together digital signals from both encoders and transmits a digital video signal over a transmission channel wherein said digital video signal comprises an output of said first encoder and an output of said second encoder.

22. A system as described in claim 21 wherein said content server is a wireless content server and wherein said video signal is wirelessly transmitted.

23. A system as described in claim 21 wherein said content server dynamically adjusts image quality of said PIP image according to available bandwidth in said transmission channel.

24. A system as described in claim 21 wherein said scaler scales said second video signal to reduce the size of said PIP image.

25. A system as described in claim 24 wherein said scaler scales said second video signal to also reduce the resolution of said PIP image.

26. A system as described in claim 21 wherein said scaler scales said second video signal to reduce the frame rate of said second video signal.

27. A system as described in claim 21 wherein said encoder reduces the picture quality of said PIP image wherein said image quality corresponds to the level of digital compression that is applied during digital encoding.

28. A system as described in claim 21 wherein said first video signal and said second video signal are supplied from a same video signal source.

29. A system as described in claim 21 further comprising said client display and wherein said client display is for receiving said video signal and for displaying said main image on a display screen and for displaying said PIP image in a portion of said display screen.

30. A system as described in claim 29 wherein said client display is also for communicating a size of said portion of said display screen to said content server via said request signal.

31. A system as described in claim 21 wherein a portion of said main image obscured by said PIP image is left blank so as to increase bandwidth space allocated to video signal components corresponding to said main image.
